(19) United States
(12) Patent Application Publication
(10) Pub. No.: US 2025/0350740 A1
(43) Pub. Date: Nov. 13, 2025

(54) PROCESSING METHOD AND APPARATUS BASED ON VERSATILE VIDEO CODING, COMPUTER DEVICE, AND STORAGE MEDIUM

(71) Applicant: SHANGHAI BILIBILI TECHNOLOGY CO., LTD., Shanghai (CN)

(72) Inventor: Kaiyue SHI, Shanghai (CN)

(21) Appl. No.: 19/196,670

(22) Filed: May 1, 2025

(30) Foreign Application Priority Data
May 8, 2024 (CN) 202410566910.X

(51) Int. Cl. H04N 19/147; H04N 19/105; H04N 19/192

(52) U.S. Cl. CPC H04N 19/147; H04N 19/105; H04N 19/192

(57) ABSTRACT

The application provide a processing method based on versatile video coding, including: performing prediction at a first resolution for a current coding unit and determining a rate-distortion cost as a current best rate-distortion cost; and performing prediction at another resolution according to following steps: constructing a prediction motion vector list of a current traversal resolution based on a reference image; determining a start search point of the current traversal resolution based on the prediction motion vector list, and determining a first rate-distortion cost; when the first rate-distortion cost and the current best rate-distortion cost meet a preset condition, skipping motion estimation and motion compensation at the current traversal resolution, and using a prediction motion vector as an actual motion vector to calculate a second rate-distortion cost of the current traversal resolution; updating the current best rate-distortion cost based on the second rate-distortion cost and the current best rate-distortion cost.

### CROSS-REFERENCE TO RELATED APPLICATION

This application claims priority to Chinese Patent Application No. 202410566910.X filed on May 8, 2024, which is incorporated herein by reference in its entirety.

### TECHNICAL FIELD

The application relates to the field of video technologies, and in particular, to a processing method and apparatus based on versatile video coding, a computer device, and a storage medium.

### BACKGROUND

Versatile video coding (VVC) is the latest coding standard released in 2020. Like a conventional coding standard, a block-based hybrid coding framework is used in VVC, which includes different modules such as intra prediction, inter prediction, transformation, quantization, and entropy coding. Inter prediction is to predict a current image by using a neighboring coded image, so as to remove video time domain redundancy. For each coding unit of the current image, motion estimation is performed based on a reference frame to obtain a best matching block, and then motion compensation is performed to obtain a final prediction block. Displacement of the best matching block to the current coding unit is referred to as a motion vector (MV), and a difference between the MV and a prediction MV (MVP) constructed based on the reference frame is an MVD, which is coded into a code stream. To improve a resolution and a range of the motion vector, VVC introduces a coding unit-level adaptive motion vector resolution (AMVR) technology. The AMVR technology allows each coding unit to select one type of resolution to represent the MVD. In general mode, there are four types of resolutions: 1/4 pixel resolution, 1/2 pixel resolution, integer pixel resolution, and 4 times integer pixel resolution.

Although the AMVR technology can more efficiently express motion information, final determination of which resolution format to use for expressing motion information requires a complete traversal. A resolution format with a minimum rate-distortion cost is selected as a best choice. If motion estimation and motion compensation are performed on a coding unit successively at the four different types of resolutions during inter prediction, time overheads are very large. Therefore, there is an acceleration algorithm for the AMVR technology in an existing encoder, so that acceleration can be implemented to some extent.

However, although the current acceleration algorithm has an acceleration effect to some extent, coding efficiency and coding performance are still greatly affected, and there is still room for further acceleration.

### SUMMARY

An objective of the application is to provide a processing method and apparatus based on versatile video coding, a computer device, and a storage medium, so as to resolve the following technical problem: currently, an acceleration algorithm for AMVR still has relatively large impact on coding efficiency and coding performance, and there is still room for further acceleration.

In one aspect of embodiments of the application, a processing method based on versatile video coding is provided, including: performing prediction at a first resolution for a current coding unit, and determining a rate-distortion cost corresponding to the first resolution as a current best rate-distortion cost; and performing prediction at another resolution different from the first resolution according to following steps, until all resolutions are traversed: constructing a prediction motion vector list of a current traversal resolution based on a reference image; determining a start search point of the current traversal resolution based on the prediction motion vector list, and determining a first rate-distortion cost of the start search point; when the first rate-distortion cost and the current best rate-distortion cost meet a preset condition, skipping motion estimation and motion compensation at the current traversal resolution, and using a prediction motion vector as an actual motion vector to calculate a second rate-distortion cost of the current traversal resolution; and updating the current best rate-distortion cost based on the second rate-distortion cost and the current best rate-distortion cost, and performing prediction at a next resolution.

Optionally, the determining a start search point of the current traversal resolution based on the prediction motion vector list includes: determining a best prediction motion vector from the prediction motion vector list based on a rate-distortion cost; and using the best prediction motion vector as the start search point.

Optionally, the preset condition includes: the first rate-distortion cost is greater than N times the current best rate-distortion cost, and N is greater than 1.

Optionally, the method further includes: determining motion complexity of the current coding unit; and determining a value of N based on the motion complexity.

Optionally, the method further includes: when calculating the rate-distortion cost, obtaining a prediction residual of the current coding unit, a quantity of bits required for coding a vector difference corresponding to a current motion vector at a current resolution, and a Lagrange multiplier of the current coding unit, where the vector difference is a difference between the actual motion vector and the prediction motion vector; and calculating the rate-distortion cost based on the prediction residual, the quantity of bits, and the Lagrange multiplier.

Optionally, the first resolution is 1/4 pixel resolution, when prediction at another resolution different from the first resolution is performed, prediction at an integer pixel resolution is performed first, and when prediction at the integer pixel resolution is performed, the updating the current best rate-distortion cost based on the second rate-distortion cost and the current best rate-distortion cost, and performing prediction at a next resolution includes: before the current best rate-distortion cost is updated, and when a multiple by which the current best rate-distortion cost is less than the second rate-distortion cost is greater than a first threshold, skipping prediction at 4 times pixel resolution, and performing prediction at 1/2 pixel resolution.

Optionally, when prediction at the integer pixel resolution is performed, the method further includes: before the current best rate-distortion cost is updated, and when the first rate-distortion cost and the current best rate-distortion cost do not meet the preset condition, continuing the motion estimation and the motion compensation at the current traversal resolution, and determining a third rate-distortion cost of the current traversal resolution; and when a multiple by which the current best rate-distortion cost is greater than the third rate-distortion cost is greater than a second threshold, skipping traversal at 1/2 pixel resolution, and performing traversal at 4 times pixel resolution.

In another aspect of the embodiments of the application, a processing apparatus based on versatile video coding is further provided, including: a determining module, configured to perform prediction at a first resolution for a current coding unit, and determine a rate-distortion cost corresponding to the first resolution as a current best rate-distortion cost; and a prediction modules, configured to perform prediction at another resolution different from the first resolution according to following steps, until all resolutions are traversed: construct a prediction motion vector list of a current traversal resolution based on a reference image; determine a start search point of the current traversal resolution based on the prediction motion vector list, and determine a first rate-distortion cost of the start search point; when the first rate-distortion cost and the current best rate-distortion cost meet a preset condition, skip motion estimation and motion compensation at the current traversal resolution, and use a prediction motion vector as an actual motion vector to calculate a second rate-distortion cost of the current traversal resolution; and update the current best rate-distortion cost based on the second rate-distortion cost and the current best rate-distortion cost, and perform prediction at a next resolution.

In another aspect of the embodiments of the application, a computer device based on versatile video coding is further provided. The computer device includes a memory, a processor, and a computer program stored in the memory and capable of running on the processor. The processor implements the steps of the foregoing processing method based on versatile video coding when executing the computer program.

In another aspect of the embodiments of the application, a computer-readable storage medium is further provided. The computer-readable storage medium stores a computer program, and the computer program may be executed by at least one processor, so that the at least one processor performs the steps of the foregoing processing method based on versatile video coding.

The processing method and apparatus based on versatile video coding, the computer device, and the storage medium according to the embodiments of the application include the following advantages:

Prediction at a first resolution is performed for a current coding unit, a rate-distortion cost corresponding to the first resolution is determined as a current best rate-distortion cost, prediction at another resolution is performed, a prediction motion vector list of a current traversal resolution is constructed based on a reference image at the time of prediction at another resolution, a start search point and a first rate-distortion cost corresponding thereto are determined based on the list, and when the first rate-distortion cost and the current best rate-distortion cost meet a preset condition, motion estimation and motion compensation at a current traversal resolution are skipped, and a prediction motion vector is used as an actual motion vector to calculate a second distortion cost of the current traversal resolution. By properly setting the preset condition, motion estimation and motion compensation at the current resolution are skipped, so that calculation complexity can be reduced, AMVR is accelerated, impact on coding efficiency and coding performance is reduced, and an acceleration effect is improved.

### BRIEF DESCRIPTION OF DRAWINGS

FIG. 1 is a schematic flowchart of a processing method based on versatile video coding according to Embodiment 1 of the application;

FIG. 2 is a flowchart of new additional steps in FIG. 1;

FIG. 3 is a flowchart of sub-steps of step S140 in FIG. 1;

FIG. 4 is another flowchart of new additional steps in FIG. 1;

FIG. 5 is a schematic flowchart of a processing method based on versatile video coding according to Embodiment 1 of the application;

FIG. 6 is an another flowchart of new additional steps in FIG. 1;

FIG. 7 is a schematic block diagram of a processing apparatus based on versatile video coding according to Embodiment 2 of the application; and

FIG. 8 is a schematic diagram of a hardware architecture of a computer device according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate an order of performing the steps, but are merely used to facilitate description of the application and differentiation of each step, and therefore cannot be construed as a limitation on the application.

The following explains terms in the application:

Versatile Video Coding (VVC), also referred to as H.266, MPEG-I Part 3, or future video coding, is a video compression standard finally determined by the Joint Video Experts Group on Jul. 6, 2020, and is a successor standard of High Efficiency Video Coding (HEVC).

Coding Unit (CU) is an important concept in video coding, and is a basic processing unit of a video frame in a compression coding process. The CU has a feature that the CU exists in a block form, and a size of the CU may range from 4×4 to maximum 128×128 (LCU, that is, Largest Coding Unit). A large CU is typically suitable for a relatively smooth part of an image, while a small CU is suitable for an edge and an area with rich textures. The CU is a basic unit of prediction coding, and a series of processes such as prediction, transformation, quantization, and entropy coding are performed in a coding process. These processes help to compress video data more effectively while maintaining video quality as much as possible.

Motion vector, in video coding, refers to relative displacement of a block to be predicted relative to a size block of the same size in a reference frame, and is used to describe a motion status of an object or an area in an image. This description may help an encoder to compress video data more effectively because the encoder can predict and code a future frame more effectively by means of understanding the motion status of the object.

Motion Vector Prediction (MVP) is mainly used to predict a motion status of a current block or image based on motion vector information in a neighboring block or an earlier coded image. The MVP is intended to reduce a quantity of bits coded by a motion vector related part and further reduce a volume of compressed data. By comparing the motion vector prediction with an actual motion vector and coding only a difference (that is, an MVD) between the motion vector prediction and the actual motion vector, more efficient data compression can be implemented.

The actual motion vector, in video coding and image processing, refers to a vector that describes an actual displacement of an object or an image block between consecutive frames. The vector includes information about a direction and a size of an object or an image block from one position to another. In a video coding process, the encoder attempts to find, by analyzing image content of consecutive frames, a correspondence between objects or image blocks in neighboring frames. The correspondence is determined by calculating the actual motion vector. Motion vector coding is a key part of video compression, and helps the encoder transmit only changed information in a subsequent frame, rather than complete image data, thereby implementing efficient data compression. The actual motion vector is obtained through calculation in a motion estimation process. Motion estimation is a search process. The encoder searches a reference frame for a block that mostly matches an image block in a current frame, and then calculates a displacement between the two blocks to obtain the actual motion vector. The vector includes not only a horizontal displacement but also a vertical displacement, and therefore is a two-dimensional vector.

Motion estimation is a technology widely used in video coding and video processing. The basic idea of the motion estimation is to divide each frame of an image sequence into many non-overlapping macro blocks and to assume that all pixels in each macro block have a same amount of displacement. Then, within a specific search range of a reference frame, for each macro block, a block that is most similar to the current block, that is, a matching block, is searched for according to a specific matching criterion. A relative displacement between the matching block and the current block is defined as a motion vector.

Motion compensation is a method for describing a difference between adjacent frames (adjacent in a coding relationship and not necessarily adjacent in a playback sequence). Specifically, the motion compensation describes how each small block of a previous frame moves to a location in a current frame. This method is often used by video compression/a video codec to reduce spatial redundancy in a video sequence, thereby increasing a compression ratio. The purpose of motion compensation is to eliminate such redundancy information, so that video data can occupy less space when being transmitted or stored.

Advanced Motion Vector (AMVR) is a motion vector resolution enhancement technology in VVC. By providing a higher resolution for a motion vector, this technology enables an encoder to describe motion of an object more accurately, thereby improving prediction accuracy and coding efficiency.

Rate-Distortion Cost (RDC) is a key indicator used to measure coding efficiency in video coding. A coded rate and distortion are combined therein to find an equilibrium point, so that the distortion is minimized at a given rate limit or the rate is minimized at a given distortion tolerance.

In a related technology, although an acceleration algorithm for the AMVR has an acceleration effect to some extent, coding efficiency and coding performance are still greatly affected, and there is still room for further acceleration.

According to the processing method based on versatile video coding in embodiments of the application, impact on coding efficiency and coding performance can be reduced, and an acceleration effect on the AMVR can be improved.

It should be noted that an execution body of the processing method based on versatile video coding according to the embodiments of the application may be a client or a server, wherein the client may be specifically but not limited to various personal computers, laptops, smartphones, tablets, and portable wearable devices. The server may be specifically implemented by using an independent server or a server cluster including multiple servers. More specifically, the execution body may be an encoder.

The following describes a processing solution based on versatile video coding by using several embodiments. For ease of understanding, the following provides an exemplary description by using the encoder as the execution body.

### Embodiment 1

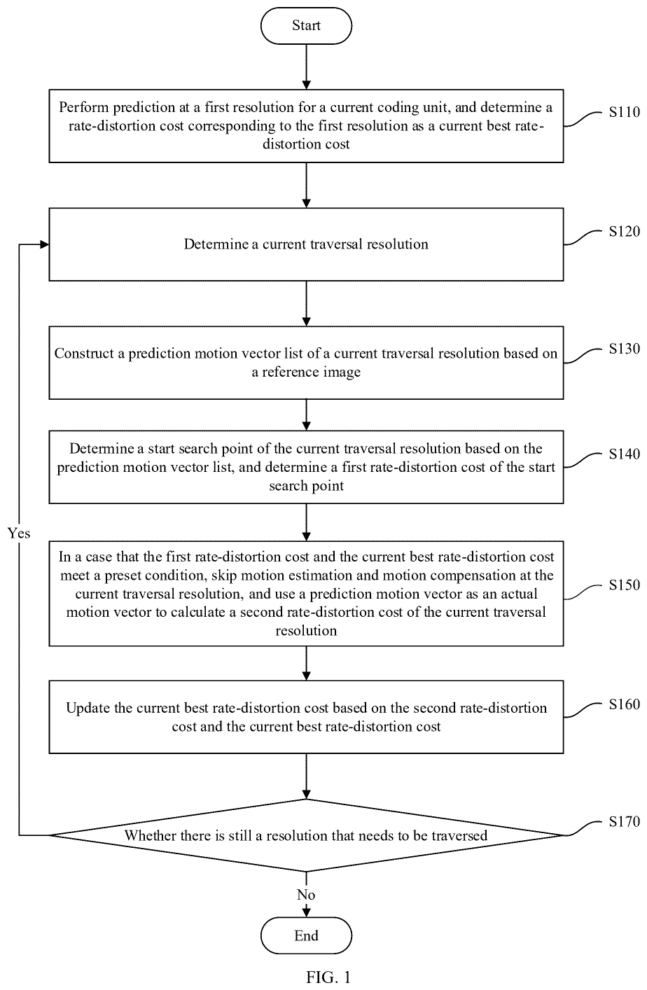

FIG. 1 is a schematic flowchart of a processing method based on versatile video coding according to Embodiment 1 of the application. The method may include steps S110 to S170. Specific descriptions are as follows:

Step S110: Perform prediction at a first resolution for a current coding unit, and determine a rate-distortion cost corresponding to the first resolution as a current best rate-distortion cost.

The first resolution may be 1/4 pixel resolution, 1/2 pixel resolution, integer pixel resolution, or 4 times integer pixel resolution. Preferably, the first resolution is 1/4 pixel resolution, and a better prediction effect may be obtained.

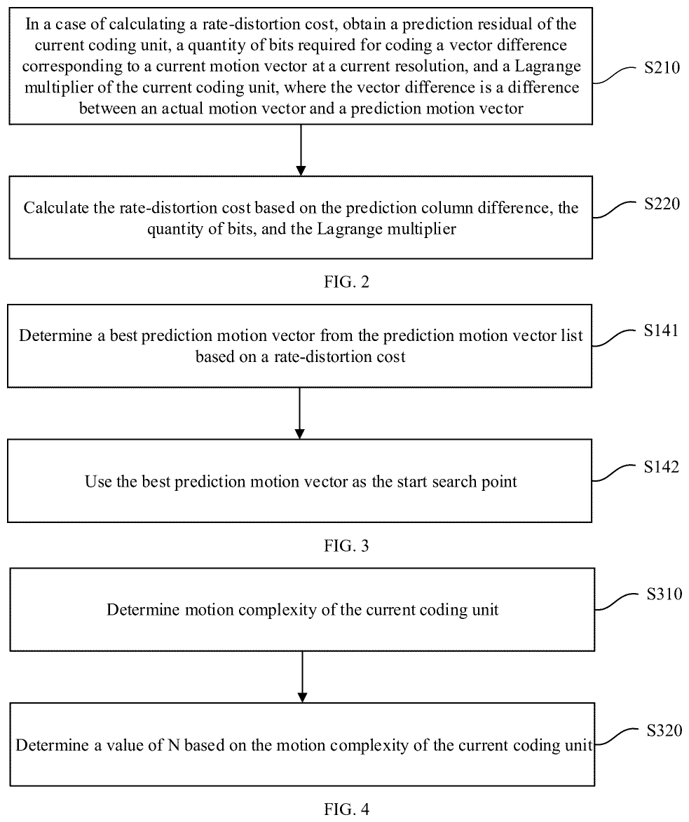

In an example embodiment, as shown in FIG. 2, the processing method based on versatile video coding according to the embodiment of the application may further include steps S210 to S220.

Step S210: When calculating a rate-distortion cost, obtain a prediction residual of the current coding unit, a quantity of bits required for coding a vector difference corresponding to a current motion vector at a current resolution, and a Lagrange multiplier of the current coding unit, wherein the vector difference is a difference between an actual motion vector and a prediction motion vector.

Step S220: Calculate the rate-distortion cost based on the prediction residual, the quantity of bits, and the Lagrange multiplier.

In the embodiment of the present application, the rate-distortion cost may be denoted as SATDCOST, and may be specifically calculated by using the following formula:

SATDCOST=SATD+λ*R.

SATD is a sum of absolute values obtained after Hadamard transform is performed on the prediction residual (the difference between the prediction block and the current coding unit that is obtained based on motion estimation and motion compensation), R is a quantity of bits required for coding an MVD corresponding to a current motion vector at a current resolution, and λ is a Lagrange multiplier used by the current coding unit.

It should be understood that the rate-distortion cost is calculated by using the foregoing formula, which has lower time overheads than an original rate-distortion cost, and can improve calculation efficiency to some extent.

Step S120: Determine a current traversal resolution.

An encoder may determine the current traversal resolution according to a preset sequence. For example, if the first resolution is 1/4 pixel resolution, the encoder may first traverse an integer pixel resolution, and then traverse 1/2 pixel resolution or 4 times integer pixel resolution.

Step S130: Construct a prediction motion vector list of the current traversal resolution based on a reference image.

Step S140: Determine a start search point of the current traversal resolution based on the prediction motion vector list, and determining a first rate-distortion cost of the start search point.

When the start search point of the current traversal resolution is determined based on the prediction motion vector list, one or more of a median prediction method, a weighted average method, a pattern matching method, a history information method, or the like may be used to determine the start search point. For example, in the median prediction method, a median value of all vectors in the prediction motion vector list is calculated, and the median value is used as the start search point. For another example, in the weighted average method, weighted averaging is performed on vectors in the prediction motion vector list based on reliability, frequency, or other factors of the vectors, and a result of weighted averaging is used as the search start point.

In an example embodiment, as shown in FIG. 3, step S140 may include steps S141 to S142.

Step S141: Determine a best prediction motion vector from the prediction motion vector list based on a rate-distortion cost.

Specifically, for each MVP in the MVP list, the encoder performs motion estimation with the MVP as a starting point to find the best matching block of the current coding unit in the reference image. After finding the best matching block, the encoder calculates the rate-distortion cost when coding using the MVP. The encoder may compare rate-distortion costs of all MVPs in the MVP list, and select an MVP with a lowest rate-distortion cost as the best MVP.

Step S142: Use the best prediction motion vector as the start search point.

It should be understood that, because corresponding determining is subsequently performed based on the rate-distortion cost of the start search point, accurate determining of the start search point helps improve accuracy of subsequent determining. In the embodiment corresponding to steps S141 to S142, the best prediction motion vector is determined from the prediction motion vector list based on the rate-distortion cost as the start search point, which can improve accuracy of determining the start search point, and effectively ensure accuracy of subsequent determining.

Step S150: When the first rate-distortion cost and the current best rate-distortion cost meet a preset condition, skip motion estimation and motion compensation at the current traversal resolution, and use a prediction motion vector as an actual motion vector to calculate a second rate-distortion cost of the current traversal resolution.

In an example embodiment, the preset condition includes that the first rate-distortion cost is greater than N times the current best rate-distortion cost, and N is greater than 1. Specifically, N may be an integer, a decimal, or a fraction, for example, 8/7. Because different encoders may differ in implementation details, performance, optimization degree, and supported features, the value of N may vary based on different encoders actually used.

When the preset condition is met, it indicates that continuing to search at the current traversal resolution is also unlikely to have a better search result. Therefore, skipping motion estimation and motion compensation at the current traversal resolution, and directly using the prediction motion vector as the actual motion vector can reduce computing complexity, improve coding efficiency and performance, and implement further acceleration.

In an example embodiment, as shown in FIG. 4, the processing method based on versatile video coding in the embodiment of the application may further include steps S310 to S320.

Step S310: Determine motion complexity of the current coding unit.

The encoder may determine the motion complexity of the current coding unit based on a quantity of bits for coding the MVD. When the quantity of bits for the MVD is relatively large, it indicates that there is a relatively large difference between the motion vector prediction and the actual motion vector, which indicates that the motion complexity of the current coding unit is relatively high. On the contrary, when the quantity of bits for the MVD is relatively small, it indicates that there is a relatively small difference between the motion vector prediction and the actual motion vector, which indicates that the motion complexity of the current coding unit is relatively low.

Optionally, a model may be trained by using a machine learning method to identify motion complexity of a coding unit. A size, a direction, and a rate of change of a motion vector of a current coding unit and a neighboring block of the current coding unit may be further analyzed. A relatively large motion vector, a rapidly changing direction, and inconsistent motion patterns generally indicate higher motion complexity.

Step S320: Determine a value of N based on the motion complexity of the current coding unit.

When determining the value of N based on the motion complexity of the current coding unit, the value may be determined with reference to the pixel resolution corresponding to the first rate-distortion cost and the current best rate-distortion cost. For example, if the pixel resolution corresponding to the first rate-distortion cost is an integer pixel resolution, and the pixel resolution corresponding to the current best rate-distortion cost is 1/4 pixel resolution, when the motion complexity of the current coding unit is relatively high, the value of N may be appropriately reduced, so that it is more easy to meet the preset condition to skip motion estimation and motion compensation at the integer pixel resolution, and finally a relatively high pixel resolution is used to code the current coding unit. On the contrary, the value of N may be appropriately increased.

In the embodiment corresponding to steps S310 to S320, the motion complexity of the current coding unit is determined, and the value of N is determined based on the motion complexity. Therefore, accuracy of determining based on the preset condition can be ensured, so that accuracy of a finally determined resolution is improved, and coding performance and efficiency are improved.

Step S160: Update the current best rate-distortion cost based on the second rate-distortion cost and the current best rate-distortion cost.

The encoder compares a magnitude of the second rate-distortion cost and that of the current best rate-distortion cost, and updates the current best rate-distortion cost based on a smaller value. For example, if the second rate-distortion cost is less than the current best rate-distortion cost, the second rate-distortion cost is updated to the current best rate-distortion cost.

Step S170: Determine whether there is still a resolution that needs to be traversed; and if yes, return to step S120; otherwise, end AMVR.

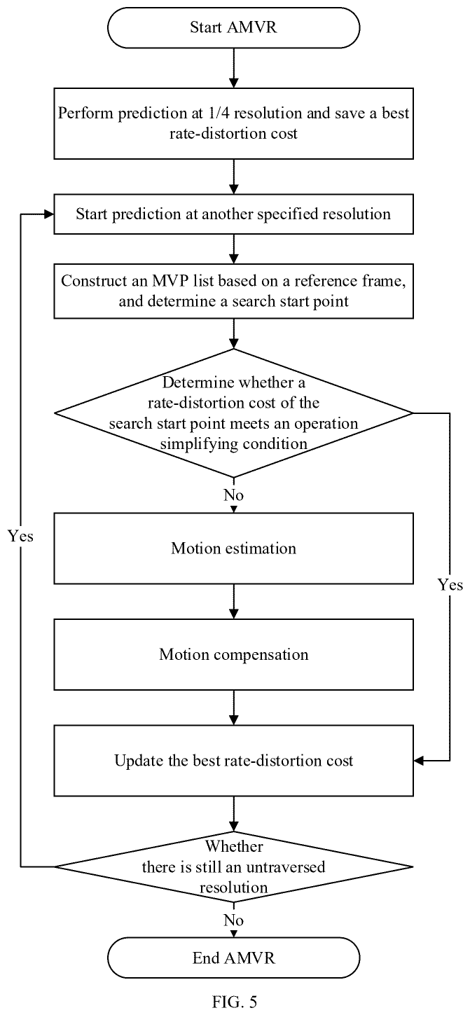

Referring to FIG. 5, FIG. 5 is a schematic flowchart of a processing method based on versatile video coding according to an embodiment of the application, which may approximately include the following process:

1. Start prediction at 1/4 pixel resolution, and save a rate-distortion cost corresponding to 1/4 pixel resolution as a current best rate-distortion cost, which is denoted as currbest.

2. Traverse an integer pixel resolution, construct an MVP list based on a reference image, determine a best MVP from the MVP list based on the rate-distortion cost as a start search point for motion estimation, and save a rate-distortion cost of the start search point, which is denoted as temCost.

3. Determine whether the rate-distortion cost of the start search point and the current best rate-distortion cost meet a preset condition:

tmpCost>currBest*Threshold.

Threshold is N. When the preset condition is met, motion estimation and motion compensation at a current traversal resolution are skipped, the MVP is directly used as an actual MV, and a rate-distortion cost of the current traversal resolution is compared with the current best rate-distortion cost, so that currBest saves the smaller one of the two. When the preset condition is not met, motion estimation and motion compensation at the current traversal resolution are continued, and then the rate-distortion cost of the current traversal resolution is compared with the current best rate-distortion cost, so that currBest saves the smaller one of the two.

4. Continue to traverse another pixel resolution, such as 1/2 pixel resolution or 4 times pixel resolution.

5. When all pixel resolutions are traversed, end AMVR.

According to the processing method based on versatile video coding provided in the embodiment of the application, prediction at a first resolution is performed for a current coding unit, a rate-distortion cost corresponding to the first resolution is determined as a current best rate-distortion cost, prediction at another resolution is performed, a prediction motion vector list of a current traversal resolution is constructed based on a reference image at the time of prediction at another resolution, a start search point and a first rate-distortion cost corresponding thereto are determined based on the list, and when the first rate-distortion cost and the current best rate-distortion cost meet a preset condition, the motion estimation and the motion compensation at a current traversal resolution are skipped, and a prediction motion vector is used as an actual motion vector to calculate a second distortion cost of the current traversal resolution. By properly setting the preset condition, the motion estimation and the motion compensation at the current resolution are skipped, so that calculation complexity can be reduced, AMVR is accelerated, impact on coding efficiency and coding performance is reduced, and an acceleration effect is improved.

In an example embodiment, the first resolution is 1/4 pixel resolution. When prediction at another resolution is performed, prediction at an integer pixel resolution is performed first, and when prediction at the integer pixel resolution is performed, updating the current best rate-distortion cost based on the second rate-distortion cost and the current best rate-distortion cost, and performing prediction at the next resolution may include: before the current best rate-distortion cost is updated and when the current best rate-distortion cost is less than a multiple of the second rate-distortion cost and is greater than a first threshold, skipping prediction at 4 times of pixel resolution, and performing prediction at 1/2 pixel resolution.

By properly setting the first threshold, when a multiple by which the current best rate-distortion cost is less than the second rate-distortion cost is greater than a first threshold, it may be determined that a rate-distortion cost of 1/4 pixel resolution is far less than a rate-distortion cost of the integer pixel resolution, so that prediction at four times pixel resolution is skipped, and only prediction at 1/2 pixel resolution is performed, so that the encoder skips prediction at a specific pixel resolution, further reducing computing complexity, and further improving coding efficiency and performance.

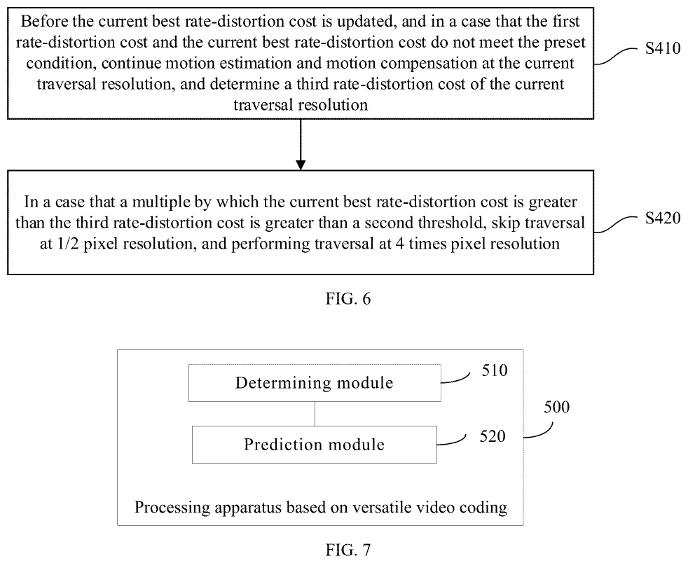

For example, in the foregoing embodiment, when prediction at the integer pixel resolution is performed, as shown in FIG. 6, the processing method based on versatile video coding in the embodiment of the application may further include steps S410 to S420.

Step S410: Before the current best rate-distortion cost is updated, and in a case that the first rate-distortion cost and the current best rate-distortion cost do not meet the preset condition, continue the motion estimation and the motion compensation at the current traversal resolution, and determine a third rate-distortion cost of the current traversal resolution.

Step S420: When a multiple by which the current best rate-distortion cost is greater than the third rate-distortion cost is greater than a second threshold, skipping traversal at 1/2 pixel resolution, and performing traversal at 4 times pixel resolution.

Similarly, by properly setting the second threshold, when a multiple by which the current best rate-distortion cost is greater than the third rate-distortion cost is greater than a second threshold, it may be determined that a rate-distortion cost of 1/4 pixel resolution is far greater than a rate-distortion cost of the integer pixel resolution, so that traversal at 1/2 pixel resolution is skipped, and only traversal at four times pixel resolution is performed, so that the encoder skips prediction at a specific pixel resolution, further reducing computing complexity, and further improving coding efficiency and performance.

### Embodiment 2

FIG. 7 is a schematic block diagram of a processing apparatus based on versatile video coding 500 according to Embodiment 2 of the application. The processing apparatus based on versatile video coding 500 may be divided into one or more program modules. The one or more program modules are stored in a storage medium and executed by one or more processors, to complete the embodiment of the application. The program modules in the embodiment of the application are a series of computer program instruction segments that can be used to complete a specific function. The following specifically describes a function of each program module in the embodiment.

As shown in FIG. 7, the processing apparatus based on versatile video coding 500 may include a determining module 510 and a prediction module 520.

The determining module 510 is configured to perform prediction at a first resolution for a current coding unit, and determine a rate-distortion cost corresponding to the first resolution as a current best rate-distortion cost; and

the prediction module 520 is configured to perform prediction at another resolution different from the first resolution according to following steps, until all resolutions are traversed: construct a prediction motion vector list of a current traversal resolution based on a reference image; determine a start search point of the current traversal resolution based on the prediction motion vector list, and determine a first rate-distortion cost of the start search point; when the first rate-distortion cost and the current best rate-distortion cost meet a preset condition, skip motion estimation and motion compensation at the current traversal resolution, and use a prediction motion vector as an actual motion vector to calculate a second rate-distortion cost of the current traversal resolution; and update the current best rate-distortion cost based on the second rate-distortion cost and the current best rate-distortion cost, and perform prediction at a next resolution.

In an example embodiment, the prediction module 520 is further configured to determine a best prediction motion vector from the prediction motion vector list based on a rate-distortion cost; and use the best prediction motion vector as the start search point.

In an example embodiment, the preset condition includes: the first rate-distortion cost is greater than N times the current best rate-distortion cost, and N is greater than 1.

In an example embodiment, the prediction module 520 is further configured to determine motion complexity of the current coding unit; and determine a value of N based on the motion complexity.

In an example embodiment, the processing apparatus based on versatile video coding 500 is further configured to: when calculating the rate-distortion cost, obtain a prediction residual of the current coding unit, a quantity of bits required for coding a vector difference corresponding to a current motion vector at a current resolution, and a Lagrange multiplier of the current coding unit, wherein the vector difference is a difference between the actual motion vector and the prediction motion vector; and calculate the rate-distortion cost based on the prediction residual, the quantity of bits, and the Lagrange multiplier.

In an example embodiment, the first resolution is 1/4 pixel resolution, when prediction at another resolution different from the first resolution is performed, prediction at an integer pixel resolution is performed first, and when prediction at the integer pixel resolution is performed, the prediction modules 520 is further configured to: before the current best rate-distortion cost is updated, and when a multiple by which the current best rate-distortion cost is less than the second rate-distortion cost is greater than a first threshold, skip prediction at 4 times pixel resolution, and perform prediction at 1/2 pixel resolution.

In an example embodiment, when prediction at the integer pixel resolution is performed, the prediction modules 520 is further configured to: before the current best rate-distortion cost is updated, and when the first rate-distortion cost and the current best rate-distortion cost do not meet the preset condition, continue the motion estimation and the motion compensation at the current traversal resolution, and determine a third rate-distortion cost of the current traversal resolution; and when a multiple by which the current best rate-distortion cost is greater than the third rate-distortion cost is greater than a second threshold, skip traversal at 1/2 pixel resolution, and perform traversal at 4 times pixel resolution.

### Embodiment 3

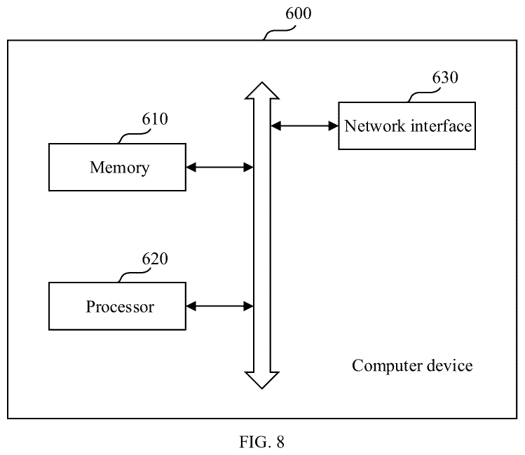

FIG. 8 is a schematic diagram of a hardware architecture of a computer device 600 applicable to a processing method based on versatile video coding according to Embodiment 3 of the application. The computer device 600 may be a device that can automatically calculate a value and/or process data based on instructions that are set or stored in advance. For example, the computer device may be a rack server, a blade server, a tower server, a cabinet server (including an independent server, or a server cluster including a plurality of servers), a gateway, or the like. As shown in FIG. 8, the computer device 600 includes at least but is not limited to a memory 610, a processor 620, and a network interface 630 that can be communicatively connected to each other through a system bus.

The memory 610 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 610 may be an internal storage module of the computer device 600, for example, a hard disk or a memory of the computer device 600. In some other embodiments, the memory 610 may be an external storage device of the computer device 600, for example, a removable hard disk, a smart media card (SMC), a secure digital (SD) card, or a flash card that is disposed on the computer device 600. Certainly, the memory 610 may alternatively include both an internal storage module of the computer device 600 and an external storage device of the computer device 600. In the embodiment, the memory 610 is usually configured to store an operating system and various application software that are installed on the computer device 600, such as program code of the processing method based on versatile video coding. In addition, the memory 610 may be further configured to temporarily store various types of data that have been output or are to be output.

The processor 620 may be a central processing unit (CPU), a controller, a microcontroller, a microprocessor, or another data processing chip in some embodiments. The processor 620 is usually configured to control an overall operation of the computer device 600, for example, perform control and processing related to data exchange or communication performed by the computer device 600. In the embodiment, the processor 620 is configured to run program code stored in the memory 610 or process data.

The network interface 630 may include a wireless network interface or a wired network interface, and the network interface 630 is usually configured to establish a communication link between the computer device 600 and another computer device. For example, the network interface 630 is configured to connect the computer device 600 to an external terminal by using a network, and establish a data transmission channel, a communication link, and the like between the computer device 600 and the external terminal. The network may be a wireless or wired network, such as, an Intranet, the Internet, a global system for mobile communications (GSM), wideband code division multiple access (WCDMA), a 4G network, a 5G network, Bluetooth, or Wi-Fi.

It should be noted that FIG. 8 shows only a computer device that has the component 610 to the component 630. However, it should be understood that implementation of all the shown components is not required, and more or fewer components may alternatively be implemented.

In the embodiment, the processing method based on versatile video coding stored in the memory 610 may be further divided into one or more program modules to be executed by one or more processors (the processor 620 in this embodiment), to complete the embodiment of the application.

### Embodiment 4

An embodiment of the application further provides a computer-readable storage medium. The computer-readable storage medium stores a computer program. When the computer program is executed by a processor, the steps of the processing method based on versatile video coding in the embodiments are implemented.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, such as program code of the processing method based on versatile video coding in the embodiments. In addition, the computer-readable storage medium may be further configured to temporarily store various types of data that have been output or are to be output.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in an order different from the order herein. Alternatively, the modules or steps are separately made into integrated circuit modules, or a plurality of modules or steps in the modules or steps are made into a single integrated circuit module for implementation. In this way, a combination of any specific hardware and software is not limited in the embodiments of the application.

The foregoing descriptions are merely preferred embodiments of the application, and are not intended to limit the scope of the application. Any equivalent structure or equivalent procedure change made based on the content of the specification and the accompanying drawings of the application is directly or indirectly applied to other related technical fields, and shall fall within the protection scope of the application.

What is claimed is:

1. A processing method based on versatile video coding, comprising:
performing prediction at a first resolution for a current coding unit, and determining a rate-distortion cost corresponding to the first resolution as a current best rate-distortion cost; and
performing prediction at another resolution different from the first resolution according to following steps, until all resolutions are traversed:
constructing a prediction motion vector list of a current traversal resolution based on a reference image;
determining a start search point of the current traversal resolution based on the prediction motion vector list, and determining a first rate-distortion cost of the start search point;
when the first rate-distortion cost and the current best rate-distortion cost meet a preset condition, skipping motion estimation and motion compensation at the current traversal resolution, and using a prediction motion vector as an actual motion vector to calculate a second rate-distortion cost of the current traversal resolution; and
updating the current best rate-distortion cost based on the second rate-distortion cost and the current best rate-distortion cost, and performing prediction at a next resolution.

2. The processing method based on versatile video coding according to claim 1, wherein the determining a start search point of the current traversal resolution based on the prediction motion vector list comprises:
determining a best prediction motion vector from the prediction motion vector list based on a rate-distortion cost; and
using the best prediction motion vector as the start search point.

3. The processing method based on versatile video coding according to claim 2, wherein the preset condition comprises: the first rate-distortion cost is greater than N times the current best rate-distortion cost, and N is greater than 1.

4. The processing method based on versatile video coding according to claim 3, further comprising:
determining motion complexity of the current coding unit; and
determining a value of N based on the motion complexity.

5. The processing method based on versatile video coding according to claim 2, further comprising:
when calculating the rate-distortion cost, obtaining a prediction residual of the current coding unit, a quantity of bits required for coding a vector difference corresponding to a current motion vector at a current resolution, and a Lagrange multiplier of the current coding unit, wherein the vector difference is a difference between the actual motion vector and the prediction motion vector; and
calculating the rate-distortion cost based on the prediction residual, the quantity of bits, and the Lagrange multiplier.

6. The processing method based on versatile video coding according to claim 1, wherein the first resolution is 1/4 pixel resolution, when prediction at another resolution different from the first resolution is performed, prediction at an integer pixel resolution is performed first, and when prediction at the integer pixel resolution is performed, the updating the current best rate-distortion cost based on the second rate-distortion cost and the current best rate-distortion cost, and performing prediction at a next resolution comprises:
before the current best rate-distortion cost is updated, and when a multiple by which the current best rate-distortion cost is less than the second rate-distortion cost is greater than a first threshold, skipping prediction at 4 times pixel resolution, and performing prediction at 1/2 pixel resolution.

7. The processing method based on versatile video coding according to claim 6, when the prediction at the integer pixel resolution is performed, further comprising:
before the current best rate-distortion cost is updated, and when the first rate-distortion cost and the current best rate-distortion cost do not meet the preset condition, continuing the motion estimation and the motion compensation at the current traversal resolution, and determining a third rate-distortion cost of the current traversal resolution; and
when a multiple by which the current best rate-distortion cost is greater than the third rate-distortion cost is greater than a second threshold, skipping traversal at 1/2 pixel resolution, and performing traversal at 4 times pixel resolution.

8. A versatile video coding based processing apparatus, comprising:
a determining module, configured to perform prediction at a first resolution for a current coding unit, and determine a rate-distortion cost corresponding to the first resolution as a current best rate-distortion cost; and
a prediction module, configured to perform prediction at another resolution different from the first resolution according to following steps, until all resolutions are traversed:
construct a prediction motion vector list of a current traversal resolution based on a reference image;
determine a start search point of the current traversal resolution based on the prediction motion vector list, and determine a first rate-distortion cost of the start search point;
when the first rate-distortion cost and the current best rate-distortion cost meet a preset condition, skip motion estimation and motion compensation at the current traversal resolution, and use a prediction motion vector as an actual motion vector to calculate a second rate-distortion cost of the current traversal resolution; and
update the current best rate-distortion cost based on the second rate-distortion cost and the current best rate-distortion cost, and perform prediction at a next resolution.

9. A computer device, comprising a memory, a processor, and a computer program stored in the memory and capable of running on the processor, wherein the computer program upon execution by the processor causes the processor to implement operations comprising:
performing prediction at a first resolution for a current coding unit, and determining a rate-distortion cost corresponding to the first resolution as a current best rate-distortion cost; and
performing prediction at another resolution different from the first resolution according to following steps, until all resolutions are traversed:
constructing a prediction motion vector list of a current traversal resolution based on a reference image;
determining a start search point of the current traversal resolution based on the prediction motion vector list, and determining a first rate-distortion cost of the start search point;
when the first rate-distortion cost and the current best rate-distortion cost meet a preset condition, skipping motion estimation and motion compensation at the current traversal resolution, and using a prediction motion vector as an actual motion vector to calculate a second rate-distortion cost of the current traversal resolution; and
updating the current best rate-distortion cost based on the second rate-distortion cost and the current best rate-distortion cost, and performing prediction at a next resolution.

10. The computer device according to claim 9, wherein the determining a start search point of the current traversal resolution based on the prediction motion vector list comprises:
determining a best prediction motion vector from the prediction motion vector list based on a rate-distortion cost; and
using the best prediction motion vector as the start search point.

11. The computer device according to claim 10, wherein the preset condition comprises: the first rate-distortion cost is greater than N times the current best rate-distortion cost, and N is greater than 1.

12. The computer device according to claim 11, the operations further comprising:
determining motion complexity of the current coding unit; and
determining a value of N based on the motion complexity.

13. The computer device according to claim 10, the operations further comprising:
when calculating the rate-distortion cost, obtaining a prediction residual of the current coding unit, a quantity of bits required for coding a vector difference corresponding to a current motion vector at a current resolution, and a Lagrange multiplier of the current coding unit, wherein the vector difference is a difference between the actual motion vector and the prediction motion vector; and
calculating the rate-distortion cost based on the prediction residual, the quantity of bits, and the Lagrange multiplier.

14. The computer device according to claim 9, wherein the first resolution is 1/4 pixel resolution, when prediction at another resolution different from the first resolution is performed, prediction at an integer pixel resolution is performed first, and when prediction at the integer pixel resolution is performed, the updating the current best rate-distortion cost based on the second rate-distortion cost and the current best rate-distortion cost, and performing prediction at a next resolution comprises:
before the current best rate-distortion cost is updated, and when a multiple by which the current best rate-distortion cost is less than the second rate-distortion cost is greater than a first threshold, skipping prediction at 4 times pixel resolution, and performing prediction at 1/2 pixel resolution.

15. The computer device according to claim 14, when the prediction at the integer pixel resolution is performed, the processor is further configured to implement steps:
before the current best rate-distortion cost is updated, and when the first rate-distortion cost and the current best rate-distortion cost do not meet the preset condition, continuing the motion estimation and the motion compensation at the current traversal resolution, and determining a third rate-distortion cost of the current traversal resolution; and
when a multiple by which the current best rate-distortion cost is greater than the third rate-distortion cost is greater than a second threshold, skipping traversal at 1/2 pixel resolution, and performing traversal at 4 times pixel resolution.

16. A non-transitory computer-readable storage medium, wherein the non-transitory computer-readable storage medium stores a computer program, the computer program is executable by at least one processor, and the computer program upon execution by the at least one processor causes the at least one processor to perform the processing method based on versatile video coding according to claim 1.

17. The non-transitory computer-readable storage medium according to claim 16, wherein the determining a start search point of the current traversal resolution based on the prediction motion vector list comprises:
determining a best prediction motion vector from the prediction motion vector list based on a rate-distortion cost; and
using the best prediction motion vector as the start search point.

18. The non-transitory computer-readable storage medium according to claim 17, wherein the preset condition comprises: the first rate-distortion cost is greater than N times the current best rate-distortion cost, and N is greater than 1.

19. The non-transitory computer-readable storage medium according to claim 18, the processor is further configured to implement operations:
determining motion complexity of the current coding unit; and
determining a value of N based on the motion complexity.

20. The non-transitory computer-readable storage medium according to claim 17, the processor is further configured to implement operations:
when calculating the rate-distortion cost, obtaining a prediction residual of the current coding unit, a quantity of bits required for coding a vector difference corresponding to a current motion vector at a current resolution, and a Lagrange multiplier of the current coding unit, wherein the vector difference is a difference between the actual motion vector and the prediction motion vector; and
calculating the rate-distortion cost based on the prediction residual, the quantity of bits, and the Lagrange multiplier.
